(19) United States
(12) Patent Application Publication
(10) Pub. No.: US 2022/0214121 A1
(43) Pub. Date: Jul. 7, 2022

(54) MULTI-MATERIAL DEVICE FOR HEAT TRANSFER AND A METHOD OF MANUFACTURE

(71) Applicant: Titomic Limited, Notting Hill, Victoria (AU)

(72) Inventors: Jeffrey David LANG, Notting Hill, Victoria (AU); Vahram PAPYAN, Notting Hill, Victoria (AU); Jayesh MODI, Notting Hill, Victoria (AU); Steven Ronald TAYLOR, Notting Hill, Victoria (AU); Bharath PARASURAMAN, Notting Hill, Victoria (AU)

(73) Assignee: Titomic Limited, Notting Hill, Victoria (AU)

(21) Appl. No.: 17/600,633

(22) PCT Filed: Apr. 6, 2020
(86) PCT No.: PCT/AU2020/050346

§ 371 Date: Oct. 1, 2021

(30) Foreign Application Priority Data
Apr. 4, 2019 (AU) 2019901156

(51) Int. Cl. F28F 21/08; C23C 4/08; C23C 4/18; C23C 24/04

(52) U.S. Cl. CPC F28F 21/081; C23C 4/08; B33Y 10/00; C23C 24/04; C23C 4/18

(57) ABSTRACT

A method of manufacturing a multi material device for heat transfer, and a multi material device is disclosed comprising: depositing, by an additive manufacturing technique, a first material onto a scaffold; depositing, by an additive manufacturing technique, a second material onto at least part of the first material, wherein, one of the first or second material is a heat transfer material having first thermal conductivity, a first chemical resistance and a first erosion resistance and the other is a rugged material of a second thermal conductivity, a second chemical resistance and a second erosion resistance, such that the second thermal conductivity is lower than the first thermal conductivity and at least one of the second chemical resistance or second erosion resistance is higher that the respective first chemical resistance or first erosion resistance.

### BACKGROUND

Heat exchange elements are traditionally made from materials that have high thermal conductivity, such as Copper, or have good corrosion/erosion behaviour, such as Titanium or Stainless Steel. However, taking these metals as an example, Stainless steel or Titanium have much lower thermal conductivity than that of copper, resulting in a trade-off in certain characteristics of performance depending on the selected material.

In many applications, it is necessary to provide corrosion or wear resistance to one side of a heat exchange system, for example corrosive sea water or poor quality combustion products, while the other side can benefit from better thermal conductivity of materials such as copper which will contact the heat exchange fluid to carry the heat away.

High-power LED lighting modules generate a lot of heat and, for their safe and prolonged use, need to be cooled efficiently.

One method commonly employed by industry for improvement to corrosion or wear resistance is to combine Titanium tubes with brazed/pressed copper fins.

Multi materials are generally considered to be difficult to manufacture. For example, explosion welding is restricted in the size and shape of parts that can be explosion welded. Vacuum brazing is restricted by size of vacuum chamber furnace and, in any case, leaks can develop from joints or residual stress can build, causing warpage and the introduction of dimensional inaccuracies.

Another consideration, is that, where there is extremely corrosive media on one side of a heat exchange, such as in nuclear power plants and other power plants using, for example, sea water for cooling, Titanium tube heat exchangers are often utilised. Using Titanium in these types of systems requires that the tubes are made sufficiently thick to withstand the pressures required. This increases the cost of expensive Titanium employed in fabrication of the tubes.

It is an object of the invention to obviate or mitigate one or more of the disadvantages of the prior art.

### SUMMARY

According to a first aspect of the present invention there is provided a method of manufacturing a multi material device for heat transfer comprising:
a) depositing, by an additive manufacturing technique, a first material on to a scaffold;
b) depositing, by an additive manufacturing technique, a second material onto at least part of the first material,
   wherein, one of the first or second material is a heat transfer material having a first thermal conductivity, a first chemical resistance and a first erosion resistance and the other is a rugged material of a second thermal conductivity, a second chemical resistance and a second erosion resistance, such that the second thermal conductivity is lower than the first thermal conductivity and at least one of the second chemical resistance or second erosion resistance is higher that the respective first chemical resistance or first erosion resistance.

According to a second aspect of the present invention there is provided a multi material device optimised for heat transfer comprising:
a) a first material, deposited by an additive manufacturing technique, on to a scaffold;
b) a second material, deposited by an additive manufacturing technique, onto at least part of the first material,
wherein, one of the first or second material is a heat transfer material having a first thermal conductivity, a first chemical resistance and a first erosion resistance and the other is a rugged material of a second thermal conductivity, a second chemical resistance and a second erosion resistance, such that the second thermal conductivity is lower than the first thermal conductivity and at least one of the second chemical resistance or second erosion resistance is higher that the respective first chemical resistance or first erosion resistance.

According to a third aspect of the present invention there is provided a heat exchanger comprising a multi material device according to the second aspect of the present invention.

According to a fourth aspect of the present invention there is provided an LED comprising a heat exchanger according to the third aspect of the present invention.

A “rugged” material should be understood to mean a material which has a higher chemical resistance and/or erosion resistance than that of the “heat transfer” material. In other words, the ruggedness of the material is, at least, a greater resistance to chemicals or erosion that the corresponding heat transfer material. Similarly, a material is considered to be a “heat transfer” material if it has a higher thermal conductivity than that of the rugged material.

Chemical resistance is the strength of a material to protect against chemical attack or solvent reaction. Tables of chemical resistance and/or compatibility are available for the assessment of this property. For example, Graco publish a “Chemical Compatibility Guide” which rates the compatibility of chemicals and materials. Clearly, chemical resistance in this context should be considered along with the application of the multi-material device. For example, if the likely corrosive medium is sea-water, the material's chemical resistance to sea water is most relevant.

Erosion resistance is the resistance of a material to wear. Whilst, potentially, not the only factor, the hardness of a material is an indicator of erosion resistance.

In an embodiment, the or each additive manufacturing technique is selected from: Kinetic spraying techniques, such as CGDS (Cold Gas Dynamic Spraying), HVOF (High Velocity Oxygen Fuel) thermal spray, plasma enhanced vapour deposition, Plasma Spraying, Direct Energy Deposition, Laser Cladding and Wire Arc Additive Manufacturing.

In an embodiment, the first material is partially removed after being deposited to form a desired size, shape, profile and/or surface finish. In particular, the first material is subjected to one or more subtractive manufacturing methods. Appropriate subtractive manufacturing techniques include: machining; milling; chemical etching; and/or selective melting.

In an embodiment, the first material, is deposited to a predetermined thickness, which is preferably 10μ to 25 mm.

In an embodiment, the heat transfer material is substantially metal and, preferably, substantially comprises one or more of the following metals: copper, aluminium, silver and/or gold.

Metal, in the context of this specification, is considered to be a chemical element such as iron; an alloy such as stainless steel; or even a molecular compound such as polymeric sulphur nitride. Of course, only metals which are suitable for the purpose in which they are disclosed would be utilised.

In an embodiment, the material has a thermal conductivity of greater than or equal to 80 W/(m·K) (watts per meter-kelvin).

In an embodiment, the second material is partially removed after being deposited. In particular, the second material is subjected to a subtractive manufacturing method to form a desired size, shape, profile and/or surface finish. Appropriate subtractive manufacturing techniques include: machining; milling; chemical etching; and/or selective melting.

In an embodiment, the second material, is deposited to a predetermined thickness, which is preferably 10 μm to 25 mm.

In an embodiment, the rugged material is substantially metal and, preferably, substantially comprises one or more of the following metals: Titanium, titanium alloys, stainless steel, nickel, nickel alloys, invar (nickel-iron alloy), niobium, niobium alloys, tantalum, tantalum alloys, metal matrix composite (MMC), and/or heterogeneous materials.

In an embodiment, the steps of depositing the first and/or second materials, and, optionally, if performed, partial removal of the first and/or second materials is repeated as necessary to meet the requirements of the multi material device including, but not limited to, the following: dimensions, configuration of layers of first and/or second materials, thermal properties and/or weight.

In an embodiment, after a step of depositing of the first and/or second material the multi-material device may be subjected to a heat treatment.

In an embodiment, the scaffold is, at least partially, removed after, at least, deposition of the first material. In particular, the scaffold may be removed by a subtractive manufacturing method including, but not limited to: melting, machining, milling and/or chemically etching/removal.

In an embodiment, the method of manufacturing includes providing two or more scaffolds prior to deposition of the first and second materials to generate two or more multi-material devices in the same manufacturing steps.

In an embodiment, a scaffold is separated from the or each other scaffold by 5 μm or greater. Preferably, a scaffold is separated from the or each other scaffold by less that 1 mm.

### BRIEF DESCRIPTION OF THE DRAWINGS

In order that the invention may be more fully understood there will now be described, by way of example only, preferred embodiments and other elements of the invention with reference to the accompanying drawings, wherein:

FIG. 1 shows a perspective view of a scaffold;

FIG. 2 shows two scaffolds back to back making a substantially cylindrical structure;

FIG. 3 shows a cylindrical scaffold;

FIG. 4 shows combined scaffolds with a first material, copper, deposited and post machined to provide a pre-determined diameter as well as grooves;

FIG. 5 shows pipe scaffold with a first material, copper, deposited and post machined to provide a pre-determined diameter as well as grooves;

FIG. 6 shows combined scaffolds with a second material, Titanium, deposited on top of a machined first material, copper, and post machined to provide a pre-determined diameter;

FIG. 7 shows a pipe scaffold with a second material, Titanium, on top of a first material, machined copper, and the second material post machined to provide a finish diameter such that the first material is visible in regions;

FIG. 8 shows one of the two scaffolds of FIG. 6 with first and second materials;

FIG. 9 shows one of the two scaffolds of FIG. 6 with machined groove inside for PCB mounting;

FIG. 10 shows a LED assembly with PCB and filter, excluding end caps and mountings configured as linear LED light fixture;

FIG. 11 shows a pipe scaffold deposited with a second material, Titanium, on top of a first material, machined copper, and post machined, in this configuration the copper is entirely covered by Titanium in finished product;

FIG. 12 shows a half section of pipe scaffold sprayed with a second material, Titanium, on top of a first material, machined copper and post machined, in this configuration the copper is entirely covered by Titanium in finished product;

FIG. 13 shows a pipe with a second material, Copper, on top of a first material, machined Titanium, and post machined, in this configuration the Titanium is entirely covered by Copper in the finished product and scaffold is removed;

FIG. 14 shows a half section view of pipe of FIG. 13; and

FIG. 15 shows a flow diagram of a method of manufacture of a multi-material device.

### DESCRIPTION

A method of manufacture of a multi material device and such a multi material device is described herein according to the invention. An embodiment of the construction method includes the use of cold-gas dynamic spraying (also known simply as “cold spray” or CGDS) to deposit a material, typically a metal coating, directly on the surface of a structure. Although, other additive manufacturing methods, which can achieve the same effect, can also be used including, but not limited to, other types of kinetic spraying, (High Velocity Oxygen Fuel) thermal spray, plasma spraying, direct energy deposition, wire arc additive manufacturing and plasma enhanced vapour deposition (plasma).

With cold spray, in general, material (metallic and/or non-metallic) in particulate form is accelerated to very high velocity (normally above 1000 m/s) in a supersonic gas jet and directed onto a substrate. On impact with the substrate, the particles undergo plastic deformation and adhere to the substrate surface. Unlike thermal spraying techniques, the material being sprayed using a cold spray method is not melted during the spraying process. The fact that the process takes place at relatively low temperature allows thermodynamic, thermal and/or chemical effects, on the surface being coated and the particles making up the coating/material, to be reduced or avoided. This means that the original structure and properties of the particles can be preserved without phase transformations, and other effects, that might otherwise be associated with high temperature material deposition/coating processes such as plasma, HVOF, or other thermal spraying processes. The underlying principles, apparatus and methodology of cold spraying are described, for example, in U.S. Pat. No. 5,302,414, which is incorporated herein by reference.

In the method of the present invention, an additive manufacturing technique is used to deposit and build-up a layer of material on the surface of a scaffold. A scaffold is a support member which has a shape and configuration that will reflect the intended shape of, at least, the inner surface of the multi-material device to be produced. In this respect the scaffold may be regarded and referred to as a support member or skeleton.

It should be readily understood that the present invention is directed towards a multi-material device suitable for use as a heat exchange component, and, particularly, a heat exchange component which is more resistant to chemical and/or physical erosion. Example embodiments of such a multi-material heat exchange device is described in relation to the figures, but it should be understood that the multi-material device has wider heat exchange applications.

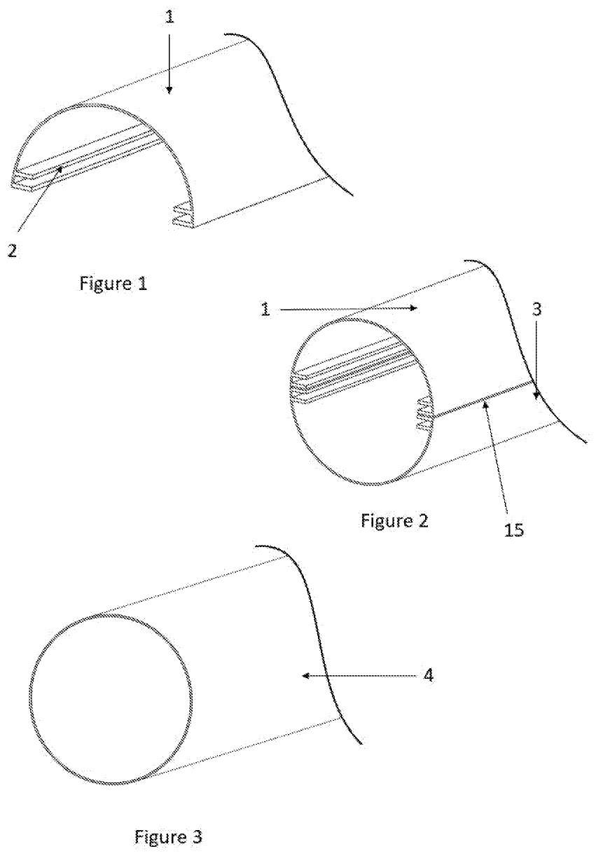

With reference to FIG. 1, an isometric view of a scaffold for a multi-material device having lens receiving portions, or ribs, 2 integrated for placement of a lens (see lens 10 in FIG. 10, for example) is shown. That is, a lens can be retained in the scaffold by inserting it into the portion between ribs 2.

With reference to FIG. 2, two scaffolds 1 and 3 are shown, which are otherwise identical to that of the scaffold of FIG. 1 and each other, mounted together in a manner which, effectively, makes a cylindrical scaffold, having a very small gap in the order of a fraction of a millimetre, and preferably greater than 5 μm and, further preferably, less than 1 mm at the interface 15. It is important to note here that the gap is, preferably, determined that during cold spray deposition, or other spray based additive manufacturing technique described in subsequent steps below, the deposit is non-continuous at the interface between the scaffolds 1 and 3, due to the predetermined gap. Thus, by manufacturing two halves in an additive manufacture deposition technique as if they were one object, it is possible to eliminate the steps of removal of deposits, such as by a subtractive manufacturing method, which in this example is machining, on each of the separate two halves. For convenience, the fixturing and clamping mechanism is not shown that is employed to keep the two halves together for purpose of spraying and machining. Clearly, this aspect of this embodiment is applicable to any other embodiment disclosed herein.

Referring now to FIG. 3, a single piece cylindrical scaffold 4 for a multi-material device is shown for use when a single cylindrical object needs to be fabricated.

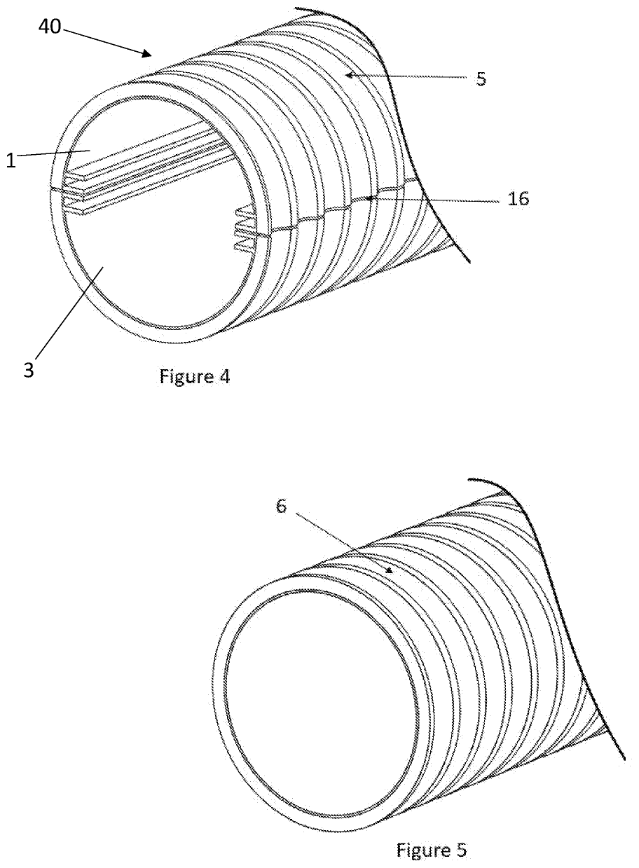

Referring now to FIG. 4, a first material 40, being a heat transfer material, for example Copper, has been deposited on to two halves of scaffolds 1,3 as described in FIG. 2 by an additive manufacturing process. After deposition of the material 40 to a desired thickness, the material 40 is subjected to a subtractive manufacturing method, such as machining, to generate a plurality of recesses 5. The material 40 is in two parts separated at gap 16, due to gap 15 between the scaffolds 1,3.

The step of deposition by an additive manufacturing process is not shown in the drawings but it is envisaged that any suitable additive manufacturing process may be used (for any embodiment disclosed herein). Although, preferably, the additive manufacturing process is a spray based process and, further preferably is cold spray. It should be understood that the scaffold will have sufficient material deposited to allow for machining, or other subtractive manufacturing method, if the multi material device is to be subjected to such a process.

Referring now to FIG. 5, the cylindrical scaffold of FIG. 4 is shown with a first material 6, being a heat transfer material, for example of Copper, that has been subjected to a subtractive manufacturing method, in this example machining, after spraying. Otherwise, the material and machining is produced in the same manner as disclosed in relation to FIG. 4.

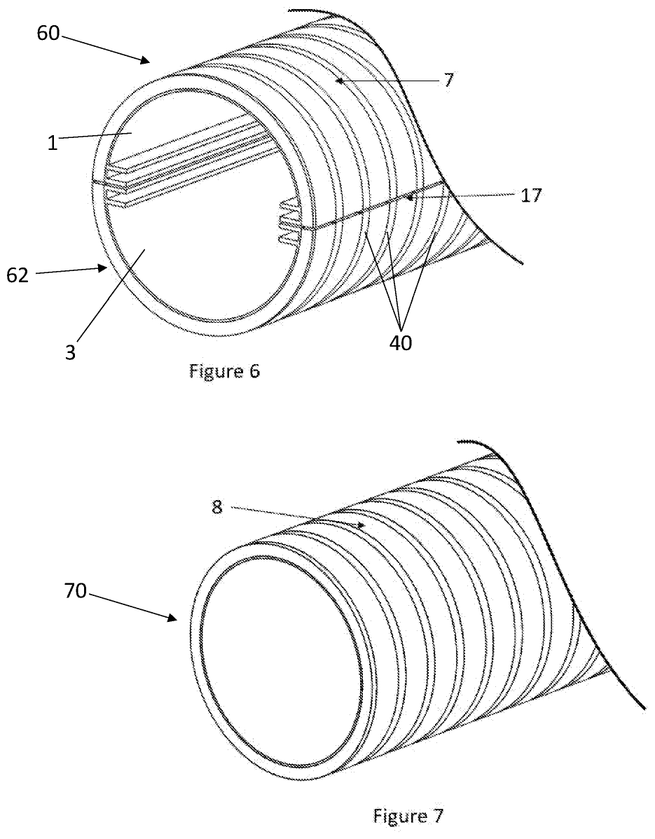

Referring now to FIG. 6, multi-material devices 60, 62 (corresponding to scaffolds 1 and 3) are shown in which a second material 7, being a rugged material, for example Titanium, has been deposited by an appropriate additive manufacturing technique and, subsequently, subjected to a subtractive manufacturing method, in this example machining. As can be seen, the machining has taken the second material 7 back such that the recesses 5 are filled (shown in FIG. 4) and the first material 40 has been exposed in some regions. As will be understood, the additive manufacturing technique can be applied all over the outer surface of the multi-material device, fully covering the first material 5, if desired, and the machined back, optionally, to improve, for example, the heat dissipation characteristics, whilst maintaining good resistance to erosion.

In this embodiment, due to the recesses 5 being machined after deposition of the first material 40, the deposition of the second material 7 fills the recesses 5 and subsequent machining exposes the first material 40 at “lands” or regions between the second material 7. In an alternative embodiment, not shown here—but discussed in embodiments below, the first material 40 remains hidden under the second material 7, whilst maintaining the profile shown in FIG. 4. As discussed in relation to FIG. 4, the two multi-material devices 60, 62 are separated at gap 17.

Referring to FIG. 7, the next step of the manufacturing process from FIG. 5 is shown, providing a multi-material device 70 utilising the same steps as discussed in relation to FIG. 6 in respect of the two half circle multi material devices 60, 62, with a second material 8, begin a rugged material, deposited on the device 70.

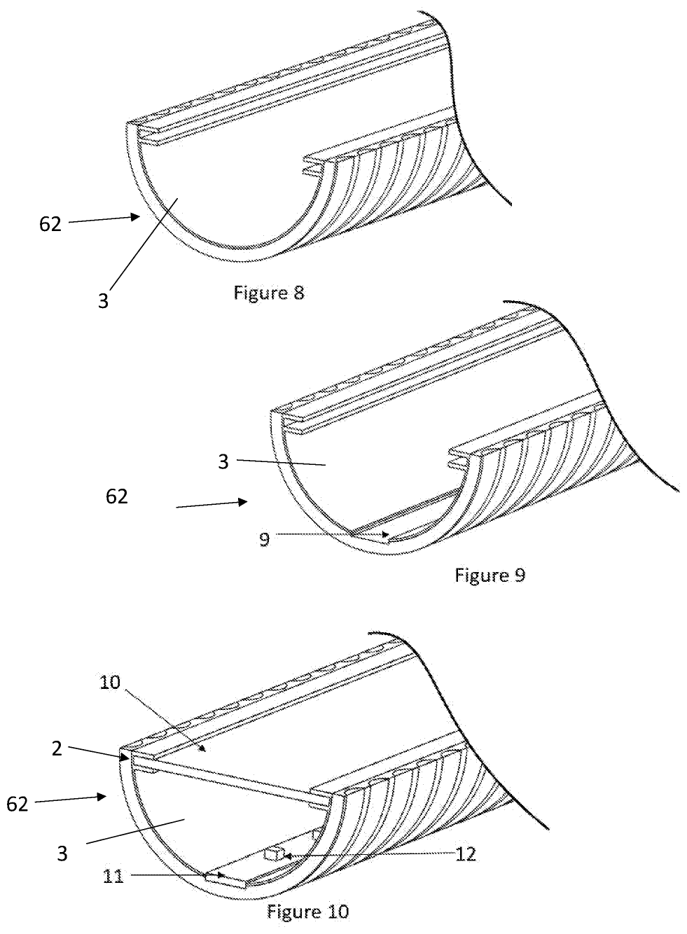

Referring now to FIG. 8, multi material device 62 is now shown with the deposition of the first and second materials and respective subtractive manufacturing method being carried out, which in this example is machining, completed. In FIG. 9, a groove 9 is machined on the inside surface of multi material device 62, providing a flat area for mounting of PCB carrying LEDs. In FIG. 10, the multi material device 62, in the form of an LED module is shown completed. A printed circuit board (PCB) 11 carries numerous LED packages 12 and is provided environmental protection and/or light beam shaping by filter/lens 10 inserted in ribs 2 provided integral to scaffold 3. As discussed above, the second material, which in this example is Titanium, leaves a portion of the first material, which in this example is Copper, exposed, thus improving thermal performance yet providing mechanical protection against impact by way of the second material interspaced among rings of the first material and, additionally, provides aesthetic enhancement to final product improving its market appeal.

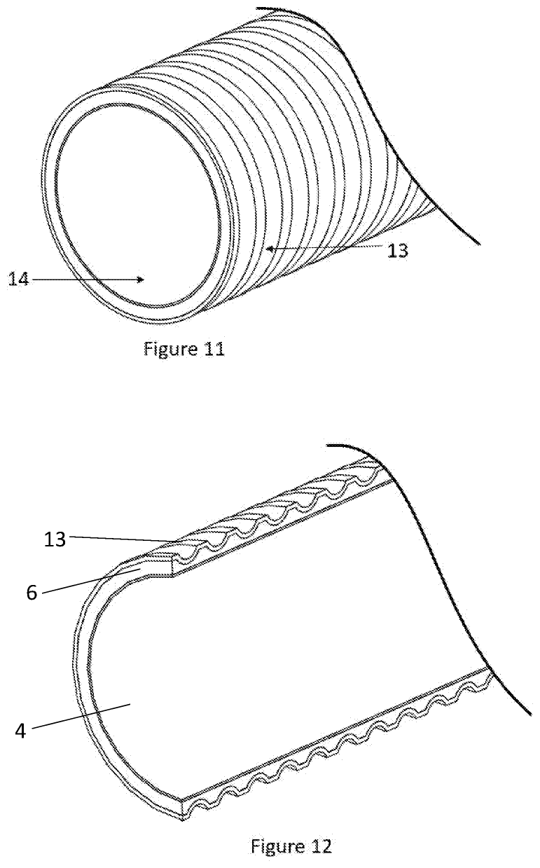

Referring now to FIG. 11 and FIG. 12, which is a cross-section of FIG. 11, a multi-material device 14 is shown, which is identical to that of multi-material device 70 but where the second material 13, being a rugged material, in this example Titanium, completely covers the first material, in this example copper, thus improving the level of protection against chemical resistance as well as improving level of ruggedness (erosion resistance).

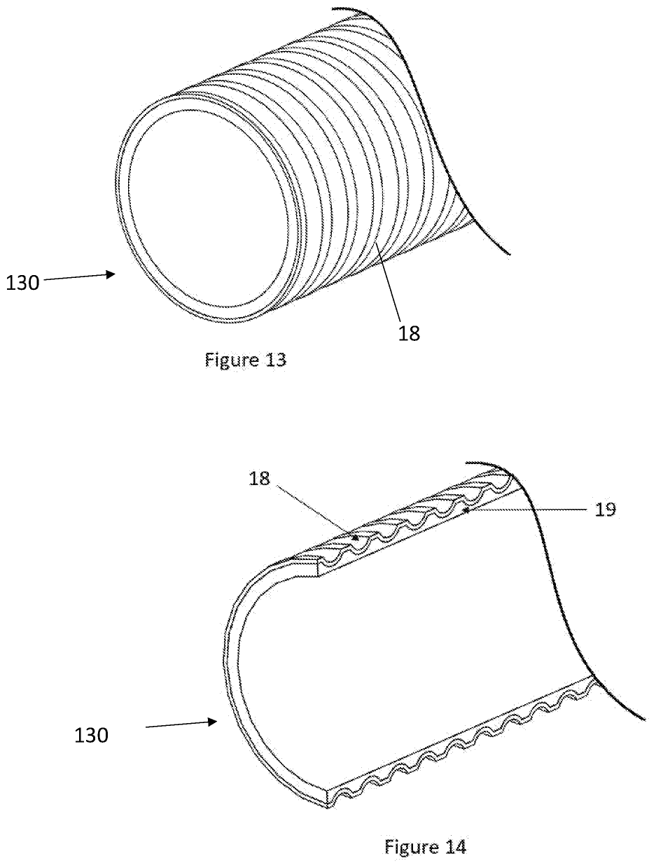

FIG. 13 and FIG. 14 shows an embodiment in which a multi-material device 130 which is produced in the same manner as the multi-material device 70, but with a first material 19 being a rugged material and a second material 18 being a heat transfer material, with the scaffold 4 removed. The process to remove the scaffold 4 may be mechanical, chemical or by vaporising or flowing away in controlled atmosphere. In this example, the multi-material device 130 is particularly useful as a pipe type product where the rugged material 19, on the inside of the multi-material device 130, is exposed to corrosive liquids, vapours or gases. For example, sea water may flow through the inside of the multi-material device 70 with the first material 19 being more resistant to the chemical action of sea water and the second material 18 improving heat transfer from the fluid contacting the outside of the multi-material device 70 to the sea water.

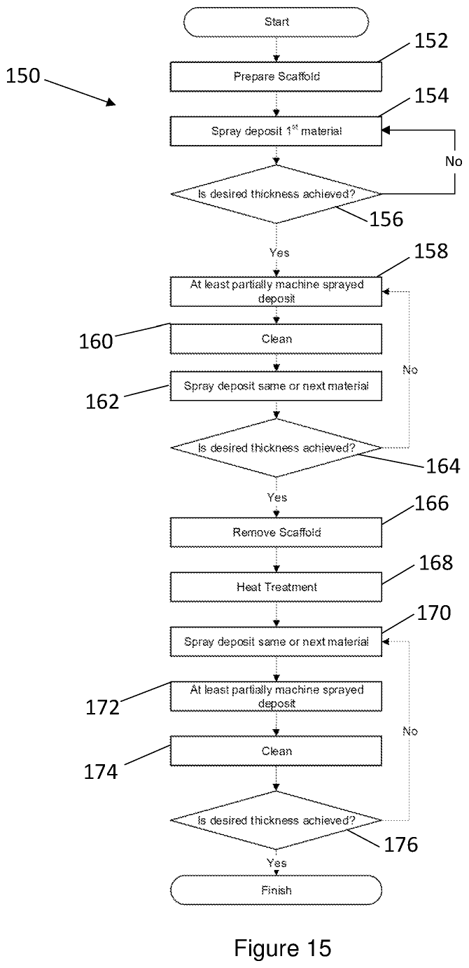

Referring now to FIG. 15, a flow diagram or a typical additive manufacturing process 150 to create a multi-material device, involving, in this example, deposition of metal material by spraying is shown. Firstly, a scaffold is prepared (step 152), which involves 3D printing, or manufacturing in any suitable manner, a support which is, typically, constructed of a material which does not contribute significantly to the strength of the final product but is easy to manufacture. Furthermore, the scaffold material may be chosen such that it is easily removable from the final product in a subtractive manufacturing method, such as by chemical removal or machining.

Step 154 involves depositing a first material on the scaffold. The deposition can by any suitable additive manufacturing technique but the preferred method is spray techniques and, most preferably, by cold spray.

Step 156 checks that the desired thickness of the first material has been achieved. If not, then further deposition of the first material at step 154 is carried out. If the thickness is sufficient, then an optional step 158 may be carried out where the first material is subjected to a subtractive manufacturing method, which in this example is machining. Step 158 is performed if the first material requires to have different thickness in particular locations or if a particular surface finish is required. Following machining, again optionally, the multi-material device is cleaned in step 160.

At this point the device is subjected to a deposition of a second material in step 162. Again, the deposition can by any suitable additive manufacturing technique but the preferred method is spray techniques and, most preferably, by cold spray.

In the same manner as with the first material, step 164 checks that the desired thickness of the second material has been achieved. If not, then, optionally, the second material can be further machined at step 158 before being, optionally, cleaned at step 160 and then further deposition of the second material at step 162.

If the thickness is sufficient, in this example, the scaffold is removed in step 166 and the device is subjected to a heat treatment at step 168.

At this stage all further steps are optional, but in this example, a further material is deposited at step 170. This further material may be one of the first or second materials or may be a different material altogether. In step 172 the further material is subjected to a subtractive manufacturing method, which in this example is machining and in step 174 cleaned. Step 176 checks that the desired thickness has been achieved and, if not, the process goes back to step 170. If it is of sufficient thickness, the multi-material device has been finished.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A method of manufacturing a multi material device for heat transfer comprising:
a) depositing, by a kinetic spraying technique, a first material on to a scaffold;
b) depositing, by a kinetic spraying technique, a second material onto at least part of the first material,
wherein, one of the first or second material is a heat transfer material having a first thermal conductivity, a first chemical resistance and a first erosion resistance and the other is a rugged material of a second thermal conductivity, a second chemical resistance and a second erosion resistance, such that the second thermal conductivity is lower than the first thermal conductivity and at least one of the second chemical resistance or second erosion resistance is higher that the respective first chemical resistance or first erosion resistance.

2. The method as claimed in claim 1, wherein the or each kinetic spraying technique is selected from: cold spray or CGDS (Cold Gas Dynamic Spraying), HVOF (High Velocity Oxygen Fuel) thermal spray, plasma spray, Direct Energy Deposition, Wire Arc Additive Manufacturing and plasma enhanced vapour deposition.

3. The method as claimed in claim 1, wherein the first material is deposited onto the scaffold by cold spray or CGDS (Cold Gas Dynamic Spraying) where the first material in particulate form is accelerated in a supersonic gas jet and directed onto the scaffold.

4. The method as claimed in claim 1, wherein the second material is deposited onto the at least part of the first material by cold spray or CGDS (Cold Gas Dynamic Spraying) where the second material in particulate form is accelerated in a supersonic gas jet and directed onto the at least part of the first material.

5. The method as claimed in claim 1, wherein the scaffold is a support member with a shape and configuration that reflects the intended shape of at least the inner surface of the multi-material device being manufactured.

6. The method as claimed in claim 1, wherein the first material is partially removed after being deposited to form a desired size, shape, profile and/or surface finish.

7. The method as claimed in claim 1, wherein the first material is deposited to a predetermined thickness, which is preferably 10p to 25 mm.

8. The method as claimed in claim 1, wherein the heat transfer material is substantially metal and, preferably, substantially comprises one or more of the following metals: copper, aluminium, silver and/or gold.

9. The method as claimed in claim 1, wherein the second material is partially removed after being deposited forms a desired size, shape, profile and/or surface finish.

10. The method as claimed in claim 1, wherein the second material is deposited to a predetermined thickness, which is preferably 10 μm to 25 mm.

11. The method as claimed in claim 1, wherein the rugged material is substantially metal and, preferably, substantially comprises one or more of the following metals: Titanium, titanium alloys, stainless, nickel, nickel alloys, invar (nickel-iron alloy), niobium, niobium alloys, tantalum, tantalum alloys, metal matrix composite (MMC), and/or heterogeneous materials.

12. The method as claimed in claim 1, wherein the steps of depositing the first and/or second materials, and, optionally, if performed, partial removal of the first and/or second materials is repeated as necessary to meet the requirements of the multi material device including, but not limited to, the following: dimensions, configuration of layers of first and/or second materials, thermal properties and/or weight.

13. The method as claimed in claim 1, wherein after a step of depositing of the first and/or second material the multi-material device may be subjected to a heat treatment.

14. The method as claimed in claim 1, wherein the scaffold is, at least partially, removed after, at least, deposition of the first material and, preferably, the scaffold is removed by a subtractive manufacturing method including, but not limited to: melting, machining and/or chemically etching/removal.

15. A multi material device optimised for heat transfer comprising:
a) a first material, deposited by a kinetic spraying technique, on to a scaffold;
b) a second material, deposited by a kinetic spraying technique, onto at least part of the first material,
wherein, one of the first or second material is a heat transfer material having a first thermal conductivity, a first chemical resistance and a first erosion resistance and the other is a rugged material of a second thermal conductivity, a second chemical resistance and a second erosion resistance, such that the second thermal conductivity is lower than the first thermal conductivity and at least one of the second chemical resistance or second erosion resistance is higher that the respective first chemical resistance or first erosion resistance.

16. The multi material device as claimed in claim 15, wherein the scaffold has a shape and configuration that reflects the shape of at least the inner surface of the multi-material device.

17. The multi material device as claimed in claim 15, comprising the scaffold.

18. A heat exchanger comprising a multi material device according to claim 15.

19. (canceled)
